(19) United States
(12) Patent Application Publication
(10) Pub. No.: US 2021/0237023 A1
(43) Pub. Date: Aug. 5, 2021

(54) MICROWAVE SYSTEM AND PROCESS FOR EXTRACTION OF ORGANIC COMPOUNDS FROM CANNABIS

(71) Applicant: Peter Mark Kearl, Grand Junction, CO (US)

(72) Inventor: Peter Mark Kearl, Grand Junction, CO (US)

(73) Assignee: Full Spectrum Organics Inc

(21) Appl. No.: 16/873,654

(22) Filed: May 28, 2020

Related U.S. Application Data
(60) Provisional application No. 62/921,061, filed on May 30, 2019.

(51) Int. Cl. B01J 19/12; B01D 5/00

(52) U.S. Cl. CPC B01J 19/126; B01D 5/0057

(57) ABSTRACT

The present invention provides a containment vessel for cannabis and other plant materials where the microwave radiation pattern of an applicator is contained within the vessel allowing the efficient heating and removal of organic compounds. The radiation pattern is designed to induce a migrating phase boundary that heats the plant material while the containment vessel allows the collection of liquid and vapor phase organic compounds.

### CROSS REFERENCE TO RELATED APPLICATIONS

This Application claims priority to Provisional Application U.S. Application No. 62/921,061 filed May 30, 2019.

### FIELD OF THE INVENTION

The present invention relates to the microwave extraction of organic compounds from plant material and advantageously cannabis plants, such as hemp, using a microwave generator and applicator to apply a directed beam of microwave radiation to produce a migrating phase boundary to cause a phase change of water and organic compounds such as terpenes, CBDs and other desired organic compounds from solid to liquid or liquid to vapor for removal from the cannabis, including rapid heating and selective creation of supercritical fluid. This invention is also applicable to the extraction of cannabin (THC) from marijuana.

### BACKGROUND OF THE INVENTION

Hemp contains Cannabinoids (Δ9-tetrahydrocannabinol, cannabigerol, cannabidiol and/or cannabinol), hereinafter CBGs, CBDs, terpenes plus other separate classes of organic compounds. One common, but relatively expensive method of extracting the CBDs is by the use of an organic solvent that leaves an undesirable solvent residue in the extracted CBDs. Pare (U.S. Pat. No. 5,458,897), Rivas (20180296616) and Li et al. (CN101342428) suggest using microwave heating in a microwave oven (cavity heating) followed by solvent extraction. Additionally, another method uses microwave energy to assist the removal of the CBDs when using a solvent, such as methanol. Eades (2018/0221522) discusses a method to reduce the water content of hemp while maintaining the terpene content using a microwave oven (cavity heating). Splinter (2013/0338234) presents a method for the extraction of naturally-derived active compounds from biomass using microwave heating in a microwave oven with a “non-organic” solvent.

Laboratory testing on hemp using a conventional microwave oven modified to collect vapor and liquid samples show an initial phase boundary occurring at 100° C. with terpenes, other organic compounds, but dominantly water vapor, collected in a cold trap followed by a second phase boundary at approximately 185 to 190° C. with crude oil collected in a screened chamber at the base of the sample container. The microwaved plant material was reduced to a carbon residue. Analysis of the crude oil derived from the laboratory experiment showed the presence of THC, CBDs and CBGs. Since a microwave oven is heating in a cavity with a standing wave electrical field, arcing is an issue even with a rotational plate to move the sample to various locations in the oven.

This invention seeks to use the advantages of microwave heating via a migrating phase boundary thereby eliminating uneven heating and arcing common in a cavity fixture such as a microwave oven plus eliminating the use of solvents to efficiently process cannabis plants. This technology can be extended for the extraction of a wide variety of compounds from various biomass sources.

### SUMMARY OF THE INVENTION

This invention concerns the extraction of water and organic compounds such as terpenes, CBGs and CBDs and other desired organic compounds from cannabis using directed microwave energy in a radiation containment vessel designed to minimize reflected power while allowing a migrating phase boundary to heat the plant material, break the cell walls of the plant allowing the collection of vapor and liquid organic compounds. The concept of a migrating phase boundary for the extraction of subterranean oil is presented in U.S. Pat. No. 7,828,057 to the inventor in this application as “launching of narrow phase boundary that reduces the viscosity . . . .” This concept of a migrating phase boundary is extended in this application to the extraction of organic compounds from plant material using a containment vessel that minimizes standing waves with a VSWR of less than 1.2 and allows a migrating phase boundary to rapidly heat the plant material releasing water and organic compounds. These compounds are collected as either vapor or liquid under controllable temperatures and pressures conditions inherent in the design of the containment vessel.

The apparatus includes a microwave source operating at 2 Gigahertz or higher frequency and providing sufficient power to liquify or vaporize the organic compounds in hemp. The energy from the source is applied through a waveguide or coaxial cable to an applicator, but not limited to aperture, leaky, and microstrip or phased array antennas, which provides a directed beam of microwave energy into hemp. A typical frequency for the microwave source is 2.45 Gigahertz. The microwave energy couples into the water and organic compounds in the plant material, rapidly heating the terpenes and water, and with the expanding plant-cell water heated to vapor that expands and breaks apart the plant cells where further heating to temperatures approximately 190° C. releases liquid CBDs commonly referred to in the industry as “crude oil”. The hemp is contained in a vessel designed to minimize reflected power with a metal screen along the base of the vessel to collect liquid CBD oil and exhaust vents where terpenes and other volatile organic compounds vaporized by microwave heating can be collected using cold traps or other similar vapor collections systems. This action would also occur when applying the microwave energy to marijuana plants.

The apparatus may further include a protecting device, such as a circulator, in the path of the microwave energy to protect the source from reflected waves. The circulator device directs any reflected waves to a dummy load. The apparatus may further include a rotator before the antenna to permit a directional antenna to be rotated in the hemp to radiate around inside the hemp for 360 degrees.

The water content in the hemp may be determined and adjusted in the field before removal and/or bailing or before the hemp is exposed to the microwave energy. If there is insufficient water in the hemp plants, water may be added. Also, the hemp may be chopped into small pieces and combined with water to form a slurry to be held in a container and microwave energy is then applied in the slurry to liquify and/or vaporize the desired organic compounds in the hemp. Ideally, hemp fresh from the fields has sufficent water content for the extraction process plus volatile terpenes that can be lost during drying or other preparation processes for extraction are maintained in the plant.

One embodiment of this invention is a method of direct extraction of organic compounds from plant material comprising the steps of: creating a phase boundary which passes through plant material in a vessel for the extraction of desired organic compounds.

A further embodiment of this invention provides a method of direct extraction of organic compounds from plant material comprising the steps of: placing the plant material in a containment vessel (processing chamber) having a VSWR of less than 1.2 during the extraction; applying continuous microwave energy from a microwave source to an applicator in the vessel; directing the energy from the applicator into the plant material in a pattern to cause a migrating phase boundary to pass from the near field to the far field in the plant material; collecting the organic compounds in vapor phase released from the plant material; collecting the organic compounds in liquid phase released from the plant material; monitoring the reflected waves from the vessel back to the source; and terminating the application of microwave energy upon detecting an increase in reflected waves above a set level.

The containment vessel is designed to allow bales of fresh-cut hemp to be placed in an air tight container, with access for a microwave applicator that produces a directional migrating phase boundary to reduce standing waves to avoid uneven heating common to conventional microwave ovens, and to the efficient collection of a wide variety of valuable organic compounds including volatile terpenes and CBDs.

The microwave recovery system includes the control of pressure and temperature necessary for the enhanced recovery of terpenes, CBDs, and other valuable organic compounds. The containment vessel allows a pressure range from vacuum to pressures sufficient to create the superheated water.

The above and other features, objects and advantages of this invention will become apparent from a consideration of the foregoing and the following description and the accompanying drawings.

### BRIEF DESCRIPTION OF THE DRAWINGS

FIG. 1 is a diagrammatic illustration of the major system components for extracting organic compounds in accordance with this invention;

FIG. 2 is is a top cut away view of the antenna power pattern in one plane surrounded by a radiation containment vessel.

FIG. 3 is a cross sectional view of the container shown in FIG. 2, with the top door in the open position.

### DETAILED DESCRIPTION OF THE PREFERRED EMBODIMENTS

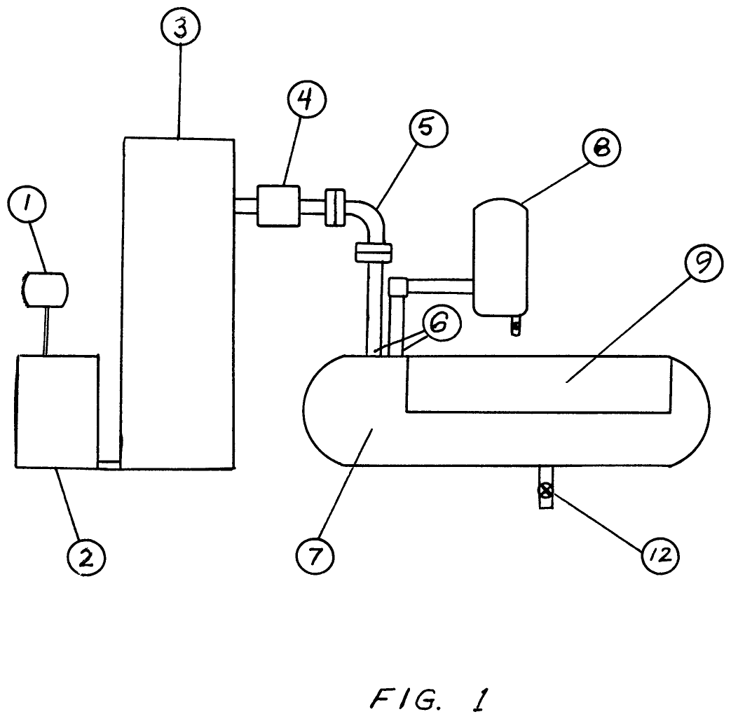

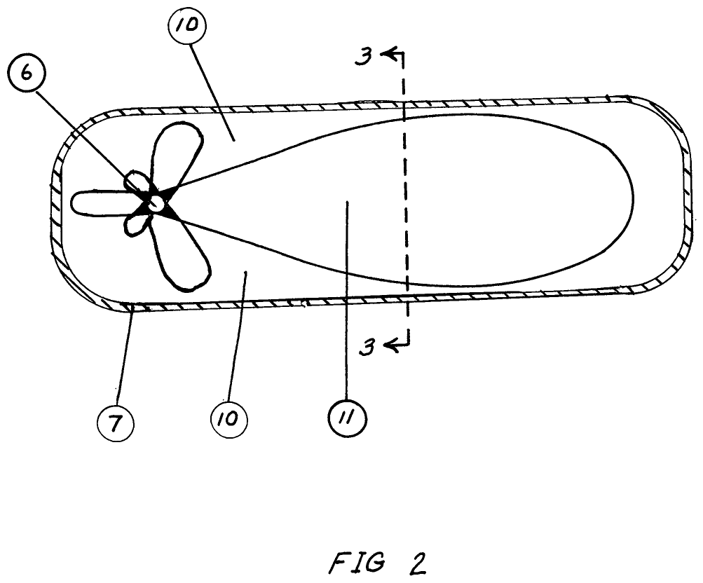

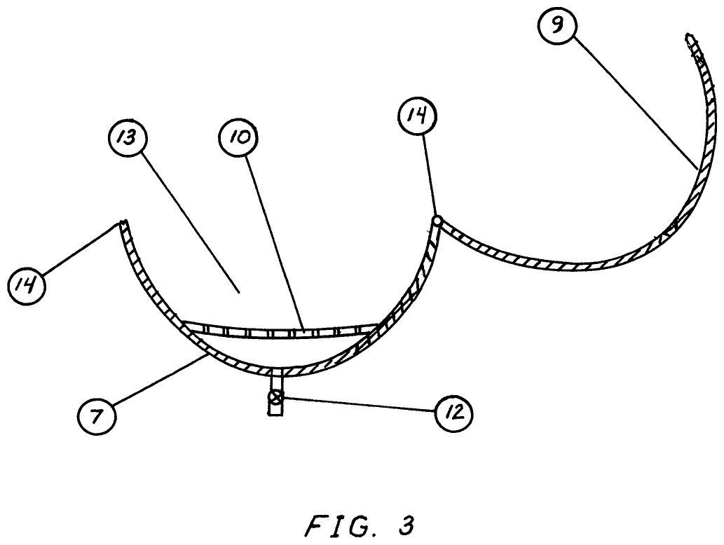

The specific embodiments of the microwave extraction system for organic compounds in cannabis are illustrated in the drawings and will be described in detail herein. FIGS. 1 through 3 illustrates the major components of a cannabis microwave extraction system.

A line voltage or generator 1, or some similar source, supplies electrical power to a power supply 2. A microwave source 3, including for example a magnetron, klystron and /or solid state energy source, provides energy down a transmission path 5. The path may comprise a waveguide or coaxial cable. A circulator 4 may be employed to prevent reflected power from damaging the microwave source. The microwave energy travels through the transmission path to an access port 6 attached to the radiation containment vessel 7. The access port 6 also allows vapors to escape the radiation containment vessel 7 and directs the vapors to a collection system 8. The radiation containment vessel 7 has a removable lid or microwave door 9 that is designed to prevent microwave leakage during operation. In this embodiment, the lid is opened to allow circular bales of hemp directly from the field to be placed into the radiation containment vessel 7. The directional applicator (not shown here) with a selected microwave power pattern 11 is placed in the access port 6. Near the base of the radiation containment vessel 7 is a metal screen 10 that the cannabis rests directly upon. The metal screen separates the hemp bales from a liquid collection system 12 isolated from microwave radiation by the metal screen. Liquid crude CBD oil is collected during microwave heating and removed from the radiation containment vessel 7 via the liquid collection system 12.

Once the hemp or other biomass is loaded into the radiation containment vessel 7 and the microwave radiation lid 9 has been properly sealed, power is applied to the applicator and a directed beam of microwave energy is launched into the hemp. A migrating phase boundary develops where microwave energy couples into a narrow region of the hemp, determined by the wavelength of the applicator, and heats the water and organic compounds. Compounds such as terpenes and other compounds having a boiling point below that of water, such as CBGs, will first be removed and will be followed by water. Once water is removed, temperature increases to the boiling points of CBDs—approximately 180° C. Once the CBDs are removed and only carbonized plant material remain in the heated region, the permittivity of the material decreases in the near field allowing the phase boundary to migrate further from the applicator and into unprocesses hemp.

During heating, sensors that are part of the circulator 4 monitor refected power. The radiation containment vessel 7 is designed to minimize reflected power. The goal of this design is to minimizes standing waves by reflected power and to maintain a VSWR of less than 1.2. This allows the even heating of a migrating phase boundary compared with uneven heating in a cavity.

Volatile organic compounds such as terpenes are collected as vapor in the collection system 8. The collection system 8 can range from a cold trap to reverse distillation of organic compounds. Pressure created by the microwave beam is sufficient to drive volatile compounds from the hemp to the vapor collection system 8. It is also possible to modify the containment vessel to use vacuum or an inert carrier gas such a nitrogen for specific applications.

It is possible to vaporize all of the organic compounds and to collect the CBGs. Further, the CBDs are collected in liquid form. CBDs typically form what is refered to as a crude oil when heated in a microwave field. Before the beam can heat CBDs past their boiling points, crude oil migrates under gravity, through the metal screen 10, and is collected in the liquid collection system 12. This feature saves power required to vaporize CBDs and perhaps prevents alteration of their chemical composition.

A preferred embodiment is the microwave induced migrating phase boundary will remove all organic compounds and the containment vessel 7 will collect all organic compounds in the hemp using power, temperature, and pressure controls. The conventional solvent extraction process, whether used solely or combined with microwave heating, is eliminated thereby increasing extraction efficiency and significantly reducing processing costs.

The processing method using a migrating phase boundary with the containment vessel 7 allows hemp taken directly from the field as bales and processed without any preparation such as drying, common to solvent extraction processes. Not only are processing costs significantly reduced but terpenes and CBGs are preserved with this approach. The high water content of the hemp provides a valuable source of water for the adsorption of microwave energy in the frequency range of 2 gigahertz or higher. The pungent oder on a summer day in a field of hemp is dominanted by terpenes. Harvesting hemp from the field and immediately processing in the microwave system described in this application maximizes the recovery of valuable terpenes. To further enhance terpene recovery, the harvested bales may be wrapped in plastic or placed in refrigerated units to preserve the volatile terpenes before processing.

A preferred embodiment are sensors to measure direct and reflected power to monitor the migration of the phase boundary and determine when reflective power levels indicate microwave processing is completed. Once the microwave energy has passed through the hemp there will be measurable reflected waves indicating the need to turn off the application of energy. Cavity heating, typical of other microwave related extraction processes, is eliminated by a focused beam inducing a migrating phase boundary. Controlled uniform heating is possible compared with cavity heating with standing waves that result in uneven heating and arcing.

While the description above contains specificity, this should not be construed as limiting the scope of the invention; but merely as providing illustrations of the presently preferred embodiment of the invention. Although preferred embodiments and method for extracting organic compounds from hemp have been described above, the inventions are not limited to the specific embodiments, but rather the scope of the inventions are to be determined as claimed. For example, the radiation containment vessel design is based on the power pattern of the applicator or antenna. Different microwave power patterns will result in changes in the vessel design in order to match the new power pattern and prevent reflected power.

For some applications, it may be beneficial to process the cannabis or hemp by reducing the moisture content or milling the cannabis into finer-grain material prior to placing the hemp into the vessel 7. A system to where fine-grain hemp is blown into the radiation containment vessel 7 via small air and or vacuum access ports and using the same ports to evacuate the carbonized plant material after microwave treatment would eliminate the removable lid/microwave door 9.

The invention claimed is:

1. A method of direct extraction of organic compounds from plant material comprising the steps of:
Placing the plant material in a containment vessel (processing chamber) having a VSWR of less than 1.2 during the extraction;
Applying continuous microwave energy from a microwave source to an applicator in the vessel;
Directing the energy from the applicator into the plant material in a pattern to cause a migrating phase boundary to pass from the near field to the far field in the plant material;
Collecting the organic compounds in vapor phase released from the plant material;
Collecting the organic compounds in liquid phase released from the plant material;
Monitoring the reflected waves from the vessel back to the source;
And terminating the application of microwave energy upon detecting an increase in reflected waves above a set level.

2. The method in accordance with claim 1 wherein the applied energy is at a level to change the phase of each desired organic compound in the plant material.

3. The method in accordance with claim 1 wherein the organic compounds include CBGs.

4. The method in accordance with claim 1 wherein the organic compounds include CBDs.

5. The method in accordance with claim 1 wherein the organic compounds include terpenes.

6. The method in accordance with claim 1 wherein the frequency of the microwave energy is above 2 GHz.

7. The method in accordance with claim 1 wherein the pattern provides uniform heating of the plant material via a migrating phase boundary and avoids the uneven heating of cavity heating.

8. The method in accordance with claim 1 wherein the plant material is placed in the vessel directly from the field without drying.

9. A system in accordance with claim 1 for extracting organic compounds from plant material using microwave energy to heat the plant material comprising a vessel to contain the plant material, the vessel during extraction having a VSWR of less than 1.2 to minimize standing waves at the applied frequency of the microwave energy.

10. The system in accordance with claim 1 wherein the frequency of the microwave energy is above 2 GHz.

11. The system in accordance with claim 1 wherein the power level of the source is determined by the size and configuration of the vessel and the size of the plant material.

12. A method in accordance with claim 1 of direct extraction of organic compounds from plant material comprising the steps of: creating a phase boundary which passes through plant material in a vessel for the extraction of desired organic compounds.
